(19) United States
(12) Patent Application Publication
(10) Pub. No.: US 2026/0140649 A1
(43) Pub. Date: May 21, 2026

(54) ADAPTIVE INPUT-OUTPUT CONNECTIVITY BASED ON STORAGE TARGET PROCESSING LOAD

(71) Applicant: Dell Products L.P., Round Rock, TX (US)

(72) Inventors: Peniel Charles, Bangalore (IN); Amit Pundalik Anchi, Bangalore (IN); Srinivas Kangyampeta, Bangalore (IN)

(21) Appl. No.: 18/951,086

(22) Filed: Nov. 18, 2024

(51) Int. Cl. G06F 3/06

(52) U.S. Cl. CPC G06F 3/0635; G06F 3/0604; G06F 3/061; G06F 3/0647; G06F 3/065; G06F 3/067

(57) ABSTRACT

An apparatus in an illustrative embodiment includes at least one processing device comprising a processor coupled to a memory. The at least one processing device is configured to obtain, for a first storage system, information characterizing input-output (IO) processing loads of respective storage targets of a second storage system, and to configure a data service involving transfer of data from the first storage system to the second storage system based at least in part on the obtained information, wherein configuring the data service comprises selecting a particular subset of the storage targets of the second storage system for use in implementing the data service based at least in part on the obtained information. The first and second storage systems illustratively comprise respective first and second clusters of storage nodes of a distributed storage system. The storage targets of the second storage system each illustratively comprise one or more NVMe controllers.

### FIELD

The field relates generally to information processing systems, and more particularly to storage in information processing systems.

### BACKGROUND

Information processing systems often include distributed storage systems comprising multiple storage nodes. These distributed storage systems may be dynamically reconfigurable under software control in order to adapt the number and type of storage nodes and the corresponding system storage capacity as needed, in an arrangement commonly referred to as a software-defined storage system. For example, in a typical software-defined storage system, storage capacities of multiple distributed storage nodes are pooled together into one or more storage pools. For applications running on a host that utilizes the software-defined storage system, such a storage system provides a logical storage object view to allow a given application to store and access data, without the application being aware that the data is being dynamically distributed among different storage nodes, which may be separated into multiple clusters of storage nodes, such as local and remote clusters. In these and other software-defined storage system arrangements that include multiple distinct clusters of storage nodes, it can be unduly difficult to perform load balancing across targets of the storage nodes, particularly when using advanced storage access protocols such as Non-Volatile Memory Express (NVMe) over Fabrics, also referred to as NVMe-oF, or NVMe over Transmission Control Protocol (TCP), also referred to as NVMe/TCP. For example, conventional approaches can lead to sub-optimal arrangements in terms of load balancing of input-output (IO) operations across storage targets of different clusters, thereby adversely impacting storage system performance.

### SUMMARY

Illustrative embodiments disclosed herein provide techniques for adaptive IO connectivity based on storage target processing load, in a software-defined storage system or other type of storage system comprising multiple clusters of storage nodes. Such techniques can advantageously facilitate determination of storage target utilization across multiple clusters, particularly in certain storage contexts such as those involving data services carried out between source and target clusters. For example, some embodiments utilize the disclosed techniques to provide enhanced load balancing in delivery of IO operations from a source cluster to a target cluster as part of a data service, such as replication, migration or copying of one or more logical storage volumes, carried out between the source and target clusters. These and other embodiments can significantly improve storage system performance.

Although some embodiments are described herein in the context of an NVMe-oF or NVMe/TCP access protocol in a software-defined storage system, it is to be appreciated that other embodiments can be implemented in other types of distributed storage systems using other storage access protocols.

In one embodiment, an apparatus comprises at least one processing device that includes a processor coupled to a memory. The at least one processing device is configured to obtain, for a first storage system, information characterizing IO processing loads of respective storage targets of a second storage system, and to configure a data service involving transfer of data from the first storage system to the second storage system based at least in part on the obtained information, wherein configuring the data service comprises selecting a particular subset of the storage targets of the second storage system for use in implementing the data service based at least in part on the obtained information.

The first and second storage systems in some embodiments comprise respective first and second distinct clusters of storage nodes of at least one distributed storage system, such as respective source and target clusters of a data service, which may comprise, for example, a replication service, a migration service and/or a copying service. Additional or alternative types of data services, in any combination, may be used. Storage targets are illustratively configurable to handle such data services in addition to or in place of handling IO operations that originate from one or more host devices.

In some embodiments, a given one of the storage targets of the second storage system comprises at least one NVMe controller of the second storage system, although other types of storage targets can be used, in any combination. The storage targets in some embodiments therefore illustratively comprise respective NVMe targets, each of which may comprise one or more NVMe controllers of the second storage system. The NVMe targets store data of a plurality of logical storage volumes illustratively comprising respective NVMe namespaces. Other types of storage targets and logical storage volumes can be used in other embodiments.

Each of one or more of the storage targets of the second storage system in some embodiments is configured to operate both as a data mobility interface to handle IO operations generated as part of one or more data services and as a host-storage interface to handle IO operations received in the storage target from one or more host devices. In such an arrangement, the IO processing loads of the respective storage targets of the second storage system illustratively include processing of IO operations received in the storage targets from the one or more host devices.

In some embodiments, at least the obtaining of the information characterizing IO processing loads of respective storage targets of a second storage system is performed in a first metadata manager associated with the first storage system. The first metadata manager associated with the first storage system may be configured to obtain the information from a second metadata manager associated with the second storage system.

The selected subset of the storage targets of the second storage system that is used in implementing the data service in some embodiments is adaptively varied over time in response to one or more changes in the IO processing loads of the respective storage targets of the second storage system.

Additionally or alternatively, obtaining the information characterizing IO processing loads of respective storage targets of the second storage system in some embodiments comprises obtaining the information from discovery log pages that are reported by only those of the storage targets having IO processing loads below a designated threshold.

Such features of illustrative embodiments are examples only, and should not be viewed as limiting in any way.

These and other illustrative embodiments include, without limitation, apparatus, systems, methods and computer program products comprising processor-readable storage media.

### BRIEF DESCRIPTION OF THE DRAWINGS

FIG. 1 is a block diagram of an information processing system incorporating functionality for adaptive IO connectivity in a distributed storage system in an illustrative embodiment.

FIG. 2 is a flow diagram of a process for adaptive IO connectivity in a distributed storage system in an illustrative embodiment.

FIG. 3 shows another example of an information processing system incorporating functionality for adaptive IO connectivity in a distributed storage system in an illustrative embodiment.

FIGS. 4 and 5 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that these and other embodiments are not restricted to the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other cloud-based system that includes one or more clouds hosting multiple tenants that share cloud resources, as well as other types of systems comprising a combination of cloud and edge infrastructure. Numerous different types of enterprise computing and storage systems are also encompassed by the term “information processing system” as that term is broadly used herein.

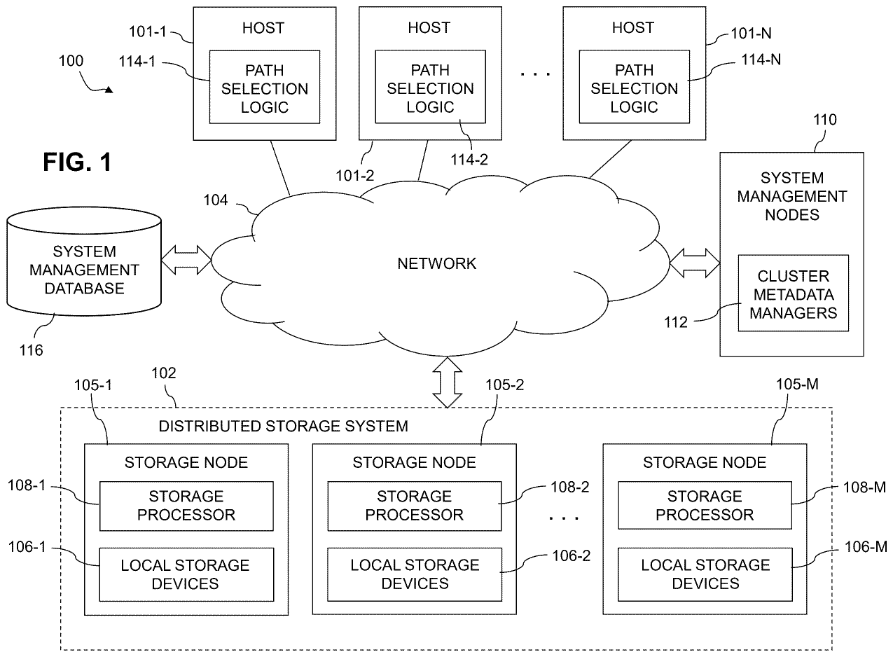

FIG. 1 shows an information processing system 100 configured in accordance with an illustrative embodiment. The information processing system 100 comprises a plurality of hosts 101-1, 101-2, . . . 101-N, collectively referred to herein as hosts 101, and a distributed storage system 102 shared by the hosts 101. The hosts 101 and distributed storage system 102 in this embodiment are configured to communicate with one another via a network 104 that illustratively utilizes protocols such as Transmission Control Protocol (TCP) and Internet Protocol (IP), and is therefore referred to herein as a TCP/IP network, although it is to be appreciated that the network 104 can operate using additional or alternative protocols. In some embodiments, the network 104 comprises a storage area network (SAN) that includes one or more Fibre Channel (FC) switches, Ethernet switches or other types of switch fabrics.

The hosts 101 are also referred to herein as respective “host devices.” It should be noted that terms such as “host” and “host device” as used herein are intended to be broadly construed, so as to encompass, for example, a host system which may comprise multiple distinct devices of various types. A given one of the hosts 101 in some embodiments can therefore comprise, for example, at least one server, as well as a wide variety of additional or alternative types and arrangements of processing devices.

The distributed storage system 102 more particularly comprises a plurality of storage nodes 105-1, 105-2, . . . 105-M, collectively referred to herein as storage nodes 105. The values N and M in this embodiment denote arbitrary integer values that in the figure are illustrated as being greater than or equal to three, although other values such as N=1, N=2, M=1 or M=2 can be used in other embodiments.

The storage nodes 105 collectively form the distributed storage system 102, which is just one possible example of what is generally referred to herein as a “distributed storage system.” Other distributed storage systems can include different numbers and arrangements of storage nodes, and possibly one or more additional components. For example, as indicated above, a distributed storage system in some embodiments may include only first and second storage nodes, corresponding to an M=2 embodiment. Some embodiments can configure a distributed storage system to include additional components in the form of a system manager implemented using one or more additional nodes.

In some embodiments, the distributed storage system 102 provides a logical address space that is divided among the storage nodes 105, such that different ones of the storage nodes 105 store the data for respective different portions of the logical address space. Accordingly, in these and other similar distributed storage system arrangements, different ones of the storage nodes 105 have responsibility for different portions of the logical address space. For a given logical storage volume, logical blocks of that logical storage volume are illustratively distributed across the storage nodes 105. Additionally or alternatively, logical blocks of one or more logical storage volumes may each be accessible via only a subset of the storage nodes 105. For example, a given one of the storage nodes 105 may store an entire logical storage volume, or multiple entire logical storage volumes.

Other types of distributed storage systems can be used in other embodiments. For example, distributed storage system 102 can comprise multiple distinct storage arrays, such as a production storage array and a backup storage array, possibly deployed at different locations. Each such storage array can comprise one or more of the storage nodes 105, and may be implemented as at least a portion of a cluster of multiple ones of the storage nodes 105.

The distributed storage system 102 in some embodiments comprises multiple clusters, with each such cluster comprising a distinct subset of the storage nodes 105. For example, the distributed storage system 102 can comprise a source cluster and a target cluster, each comprising a different subset of the storage nodes 105, where the source cluster initiates data services, such as replication, migration and/or copying, to be carried out using storage targets of the storage nodes of the second cluster.

Accordingly, in some embodiments, one or more of the storage nodes 105 may each be viewed as comprising at least a portion of a separate storage array or storage cluster with its own logical identifier (e.g., address) space. Alternatively, the storage nodes 105 can be viewed as collectively comprising one or more storage arrays. The term “storage node” as used herein is therefore intended to be broadly construed.

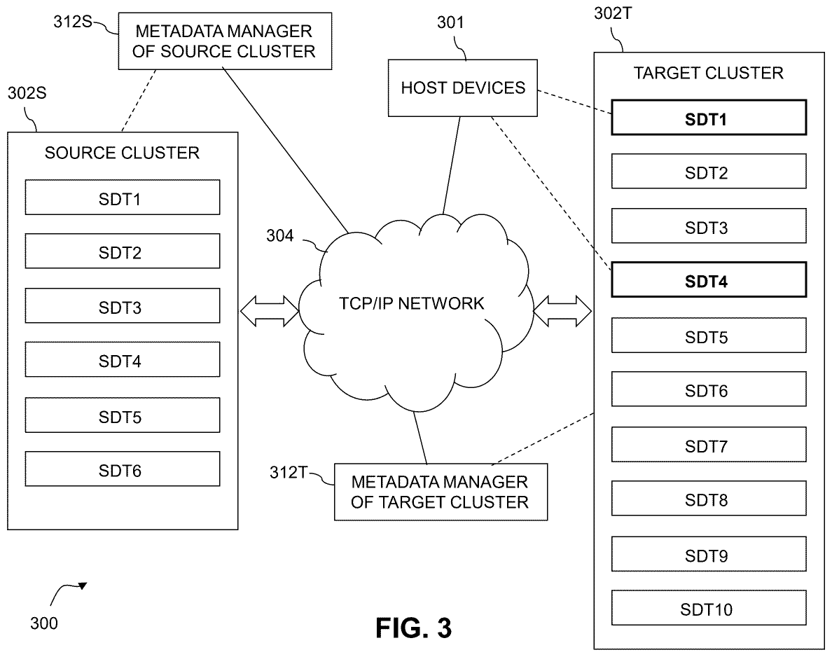

In some embodiments, the distributed storage system 102 comprises a software-defined storage system and the storage nodes 105 comprise respective software-defined storage server nodes of the software-defined storage system, such nodes also being referred to herein as SDS server nodes, where SDS denotes software-defined storage. Accordingly, the number and types of storage nodes 105 can be dynamically expanded or contracted under software control in some embodiments. Examples of such software-defined storage systems will be described in more detail below in conjunction with FIG. 3.

It is to be appreciated, however, that techniques disclosed herein can be implemented in other embodiments in stand-alone storage arrays or other types of storage systems that are not distributed across multiple storage nodes. The disclosed techniques are therefore applicable to a wide variety of different types of storage systems. The distributed storage system 102 is just one illustrative example.

In the distributed storage system 102, each of the storage nodes 105 is illustratively configured to interact with one or more of the hosts 101. The hosts 101 illustratively comprise servers or other types of computers of an enterprise computer system, cloud-based computer system or other arrangement of multiple compute nodes, each associated with one or more system users.

The hosts 101 in some embodiments illustratively provide compute services such as execution of one or more applications on behalf of each of one or more users associated with respective ones of the hosts 101. Such applications illustratively generate input-output (IO) operations that are processed by a corresponding one of the storage nodes 105. The term “input-output” as used herein refers to at least one of input and output. For example, IO operations may comprise write requests and/or read requests directed to logical addresses of a particular logical storage volume of one or more of the storage nodes 105. These and other types of IO operations are also generally referred to herein as IO requests.

The IO operations that are currently being processed in the distributed storage system 102 in some embodiments are referred to herein as outstanding IOs that have been admitted by the storage nodes 105 to further processing within the system 100. The storage nodes 105 are illustratively configured to queue IO operations arriving from one or more of the hosts 101 in one or more sets of IO queues. In some embodiments, each of the storage nodes 105 comprises one or more NVMe targets or other types of targets of the distributed storage system 102, and each such target is configured with a plurality of IO queues. Each such IO queue may have a corresponding TCP connection or other type of network connection with one or more of the hosts 101. Such IO queues and network connections are considered examples of “network resources” as that term is broadly used herein.

The storage nodes 105 illustratively comprise respective processing devices of one or more processing platforms. For example, the storage nodes 105 can each comprise one or more processing devices each having a processor and a memory, possibly implementing virtual machines and/or containers, although numerous other configurations are possible.

The storage nodes 105 can additionally or alternatively be part of cloud infrastructure, such as a cloud-based system implementing Storage-as-a-Service (STaaS) functionality.

The storage nodes 105 may be implemented on a common processing platform, or on separate processing platforms. In the case of separate processing platforms, there may be a single storage node per processing platform or multiple storage nodes per processing platform.

The hosts 101 are illustratively configured to write data to and read data from the distributed storage system 102 comprising storage nodes 105 in accordance with applications executing on those hosts 101 for system users.

The term “user” herein is intended to be broadly construed so as to encompass numerous arrangements of human, hardware, software or firmware entities, as well as combinations of such entities. Compute and/or storage services may be provided for users under a Platform-as-a-Service (PaaS) model, an Infrastructure-as-a-Service (IaaS) model and/or a Function-as-a-Service (FaaS) model, although it is to be appreciated that numerous other cloud infrastructure arrangements could be used. Also, illustrative embodiments can be implemented outside of the cloud infrastructure context, as in the case of a stand-alone computing and storage system implemented within a given enterprise. Combinations of cloud and edge infrastructure can also be used in implementing a given information processing system to provide services to users.

Communications between the components of system 100 can take place over additional or alternative networks, including a global computer network such as the Internet, a wide area network (WAN), a local area network (LAN), a satellite network, a telephone or cable network, a cellular network such as 4G or 5G cellular network, a wireless network such as a WiFi or WiMAX network, or various portions or combinations of these and other types of networks. The system 100 in some embodiments therefore comprises one or more additional networks other than network 104 each comprising processing devices configured to communicate using TCP, IP and/or other communication protocols.

As a more particular example, some embodiments may utilize one or more high-speed local networks in which associated processing devices communicate with one another utilizing Peripheral Component Interconnect express (PCIe) interface cards of those devices, that support networking protocols such as InfiniBand or Fibre Channel, in addition to or in place of TCP/IP. Numerous alternative networking arrangements are possible in a given embodiment, as will be appreciated by those skilled in the art. Additional examples include remote direct memory access (RDMA) over Converged Ethernet (RoCE) or RDMA over iWARP.

The first storage node 105-1 comprises a plurality of storage devices 106-1 and an associated storage processor 108-1. The storage devices 106-1 illustratively store metadata pages and user data pages associated with one or more storage volumes of the distributed storage system 102. The storage volumes illustratively comprise respective logical units (LUNs) or other types of logical storage volumes (e.g., NVMe namespaces). The storage devices 106-1 in some embodiments more particularly comprise local persistent storage devices of the first storage node 105-1. Such persistent storage devices are local to the first storage node 105-1, but remote from the second storage node 105-2, the storage node 105-M and any other ones of other storage nodes 105 Each of the other storage nodes 105-2 through 105-M is assumed to be configured in a manner similar to that described above for the first storage node 105-1. Accordingly, by way of example, storage node 105-2 comprises a plurality of storage devices 106-2 and an associated storage processor 108-2, and storage node 105-M comprises a plurality of storage devices 106-M and an associated storage processor 108-M.

As indicated previously, the storage devices 106-2 through 106-M illustratively store metadata pages and user data pages associated with one or more storage volumes of the distributed storage system 102, such as the above-noted LUNs or other types of logical storage volumes. The storage devices 106-2 in some embodiments more particularly comprise local persistent storage devices of the storage node 105-2. Such persistent storage devices are local to the storage node 105-2, but remote from the first storage node 105-1, the storage node 105-M, and any other ones of the storage nodes 105. Similarly, the storage devices 106-M in some embodiments more particularly comprise local persistent storage devices of the storage node 105-M. Such persistent storage devices are local to the storage node 105-M, but remote from the first storage node 105-1, the second storage node 105-2, and any other ones of the storage nodes 105.

The local persistent storage of a given one of the storage nodes 105 illustratively comprises the particular local persistent storage devices that are implemented in or otherwise associated with that storage node.

The storage processors 108 of the storage nodes 105 may include additional modules and other components typically found in conventional implementations of storage processors and storage systems, although such additional modules and other components are omitted from the figure for clarity and simplicity of illustration.

Additionally or alternatively, the storage processors 108 in some embodiments can comprise or be otherwise associated with one or more write caches and one or more write cache journals, both also illustratively distributed across the storage nodes 105 of the distributed storage system. It is further assumed in illustrative embodiments that one or more additional journals are provided in the distributed storage system, such as, for example, a metadata update journal and possibly other journals providing other types of journaling functionality for IO operations. Illustrative embodiments disclosed herein are assumed to be configured to perform various destaging processes for write caches and associated journals, and to perform additional or alternative functions in conjunction with processing of IO operations.

The storage devices 106 of the storage nodes 105 illustratively comprise solid state drives (SSDs). Such SSDs are implemented using non-volatile memory (NVM) devices such as flash memory. Other types of NVM devices that can be used to implement at least a portion of the storage devices 106 include, for example, non-volatile random access memory (NVRAM), phase-change RAM (PC-RAM), magnetic RAM (MRAM), resistive RAM, and spin torque transfer magneto-resistive RAM (STT-MRAM). These and various combinations of multiple different types of NVM devices may also be used. For example, hard disk drives (HDDs) can be used in combination with or in place of SSDs or other types of NVM devices.

However, it is to be appreciated that other types of storage devices can be used in other embodiments. For example, a given storage system as the term is broadly used herein can include a combination of different types of storage devices, as in the case of a multi-tier storage system comprising a flash-based fast tier and a disk-based capacity tier. In such an embodiment, each of the fast tier and the capacity tier of the multi-tier storage system comprises a plurality of storage devices with different types of storage devices being used in different ones of the storage tiers. For example, the fast tier may comprise flash drives while the capacity tier comprises HDDs. The particular storage devices used in a given storage tier may be varied in other embodiments, and multiple distinct storage device types may be used within a single storage tier. The term “storage device” as used herein is intended to be broadly construed, so as to encompass, for example, SSDs, HDDs, flash drives, hybrid drives or other types of storage devices. Such storage devices are examples of local persistent storage devices that may be used to implement at least a portion of the storage devices 106 of the storage nodes 105 of the distributed storage system of FIG. 1.

In some embodiments, the storage nodes 105 collectively provide a distributed storage system, although the storage nodes 105 can be used to implement other types of storage systems in other embodiments. One or more such storage nodes can be associated with at least one storage array. Additional or alternative types of storage products that can be used in implementing a given storage system in illustrative embodiments include software-defined storage, cloud storage and object-based storage. Combinations of multiple ones of these and other storage types can also be used.

As indicated above, the storage nodes 105 in some embodiments comprise respective software-defined storage server nodes of a software-defined storage system, in which the number and types of storage nodes 105 can be dynamically expanded or contracted under software control using software-defined storage techniques.

The term “storage system” as used herein is therefore intended to be broadly construed, and should not be viewed as being limited to certain types of storage systems, such as content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

In some embodiments, communications between the hosts 101 and the storage nodes 105 comprise NVMe commands of an NVMe storage access protocol, for example, as described in the NVM Express Base Specification, Revision 2.0c, October 2022, and its associated NVM Express Command Set Specification and NVM Express TCP Transport Specification, all of which are incorporated by reference herein. Other examples of NVMe storage access protocols that may be utilized in illustrative embodiments disclosed herein include NVMe over Fabrics, also referred to herein as NVMe-oF, and NVMe over TCP, also referred to herein as NVMe/TCP. Other embodiments can utilize other types of storage access protocols, including, for example, NVMe over Fibre Channel, also referred to herein as NVMe/FC.

As another example, communications between the hosts 101 and the storage nodes 105 in some embodiments can be implemented using Small Computer System Interface (SCSI) commands and the Internet SCSI (iSCSI) protocol.

Other types of commands may be used in other embodiments, including commands that are part of a standard command set, or custom commands such as a “vendor unique command” or VU command that is not part of a standard command set. The term “command” as used herein is therefore intended to be broadly construed, so as to encompass, for example, a composite command that comprises a combination of multiple individual commands. Numerous other types, formats and configurations of IO operations can be used in other embodiments, as that term is broadly used herein.

Some embodiments disclosed herein are configured to utilize one or more RAID arrangements to store data across the storage devices 106 in each of one or more of the storage nodes 105 of the distributed storage system 102. Other embodiments can utilize other data protection techniques, such as, for example, Erasure Coding (EC), instead of one or more RAID arrangements.

The RAID arrangement can comprise, for example, a RAID 5 arrangement supporting recovery from a failure of a single one of the plurality of storage devices, a RAID 6 arrangement supporting recovery from simultaneous failure of up to two of the storage devices, or another type of RAID arrangement. For example, some embodiments can utilize RAID arrangements with redundancy higher than two.

The term “RAID arrangement” as used herein is intended to be broadly construed, and should not be viewed as limited to RAID 5, RAID 6 or other parity RAID arrangements. For example, a RAID arrangement in some embodiments can comprise combinations of multiple instances of distinct RAID approaches, such as a mixture of multiple distinct RAID types (e.g., RAID 1 and RAID 6) over the same set of storage devices, or a mixture of multiple stripe sets of different instances of one RAID type (e.g., two separate instances of RAID 5) over the same set of storage devices. Other types of parity RAID techniques and/or non-parity RAID techniques can be used in other embodiments.

Such a RAID arrangement is illustratively established by the storage processors 108 of the respective storage nodes 105. The storage devices 106 in the context of RAID arrangements herein are also referred to as “disks” or “drives.” A given such RAID arrangement may also be referred to in some embodiments herein as a “RAID array.”

The RAID arrangement used in an illustrative embodiment includes a plurality of devices, each illustratively a different physical storage device of the storage devices 106. Multiple such physical storage devices are typically utilized to store data of a given LUN or other logical storage volume in the distributed storage system. For example, data pages or other data blocks of a given LUN or other logical storage volume can be “striped” along with its corresponding parity information across multiple ones of the devices in the RAID arrangement in accordance with RAID 5 or RAID 6 techniques.

A given RAID 5 arrangement defines block-level striping with single distributed parity and provides fault tolerance of a single drive failure, so that the array continues to operate with a single failed drive, irrespective of which drive fails. For example, in a conventional RAID 5 arrangement, each stripe includes multiple data blocks as well as a corresponding p parity block. The p parity blocks are associated with respective row parity information computed using well-known RAID 5 techniques. The data and parity blocks are distributed over the devices to support the above-noted single distributed parity and its associated fault tolerance.

A given RAID 6 arrangement defines block-level striping with double distributed parity and provides fault tolerance of up to two drive failures, so that the array continues to operate with up to two failed drives, irrespective of which two drives fail. For example, in a conventional RAID 6 arrangement, each stripe includes multiple data blocks as well as corresponding p and q parity blocks. The p and q parity blocks are associated with respective row parity information and diagonal parity information computed using well-known RAID 6 techniques. The data and parity blocks are distributed over the devices to collectively provide a diagonal-based configuration for the p and q parity information, so as to support the above-noted double distributed parity and its associated fault tolerance.

In such RAID arrangements, the parity blocks are typically not read unless needed for a rebuild process triggered by one or more storage device failures.

These and other references herein to RAID 5, RAID 6 and other particular RAID arrangements are only examples, and numerous other RAID arrangements can be used in other embodiments. Also, other embodiments can store data across the storage devices 106 of the storage nodes 105 without using RAID arrangements.

In some embodiments, the storage nodes 105 of the distributed storage system of FIG. 1 are connected to each other in a full mesh network, and are collectively managed by a system manager. A given set of local persistent storage devices or other storage devices 106 on a given one of the storage nodes 105 is illustratively implemented in a disk array enclosure (DAE) or other type of storage array enclosure of that storage node. Each of the storage nodes 105 illustratively comprises a CPU or other type of processor, a memory, a network interface card (NIC) or other type of network interface, and its corresponding storage devices 106, possibly arranged as part of a DAE of the storage node.

In some embodiments, different ones of the storage nodes 105 are associated with the same DAE or other type of storage array enclosure. The system manager is illustratively implemented as a management module or other similar management logic instance, possibly running on one or more of the storage nodes 105, on another storage node and/or on a separate non-storage node of the distributed storage system.

As a more particular non-limiting illustration, the storage nodes 105 in some embodiments are paired together in an arrangement referred to as a “brick,” with each such brick being coupled to a different DAE comprising multiple drives, and each node in a brick being connected to the DAE and to each drive through a separate connection. The system manager may be running on one of the two nodes of a first one of the bricks of the distributed storage system. Again, numerous other arrangements of the storage nodes are possible in a given distributed storage system as disclosed herein.

The system 100 as shown further comprises a plurality of system management nodes 110 that are illustratively configured to provide system management functionality of the type noted above. Such functionality in the present embodiment illustratively further involves utilization of cluster metadata managers 112 and a system management database 116. In some embodiments, at least portions of the system management nodes 110 and their associated cluster metadata managers 112 are distributed over the storage nodes 105. For example, a designated subset of the storage nodes 105 can each be configured to include a corresponding one of the cluster metadata managers 112. Other system management functionality provided by system management nodes 110 can be similarly distributed over a subset of the storage nodes 105. In some embodiments, the cluster metadata managers 112 are implemented in or otherwise associated with respective control plane servers or other types of system management entities.

The system management database 116 stores configuration and operation information of the system 100 and portions thereof are illustratively accessible to various system administrators such as host administrators and storage administrators.

The hosts 101-1, 101-2, . . . 101-N include respective instances of path selection logic 114-1, 114-2, . . . 114-N. Such instances of path selection logic 114 are illustratively utilized in supporting functionality for adaptive IO connectivity in the distributed storage system 102, illustratively through interaction with IO processing logic instances implemented in respective ones of the storage processors 108 of the storage nodes 105, as described in more detail below.

In some embodiments, each of the storage nodes 105 of the distributed storage system 102 is assumed to comprise multiple controllers associated with a corresponding target of that storage node. Such a “target” as that term is broadly used herein is illustratively a destination end of one or more paths from one or more of the hosts 101 to the storage node, and may comprise, for example, an NVMe subsystem of the storage node, although other types of targets can be used in other embodiments. It should be noted that different types of targets may be present in NVMe embodiments than are present in other embodiments that use other storage access protocols, such as SCSI embodiments. Accordingly, the types of targets that may be implemented in a given embodiment can vary depending upon the particular storage access protocol being utilized in that embodiment, and/or other factors. Similarly, the types of initiators can vary depending upon the particular storage access protocol, and/or other factors. Again, terms such as “initiator” and “target” as used herein are intended to be broadly construed, and should not be viewed as being limited in any way to particular types of components associated with any particular storage access protocol.

The paths that are selected by instances of path selection logic 114 of the hosts 101 for delivering IO operations from the hosts 101 to the distributed storage system 102 are associated with respective initiator-target pairs, as described in more detail elsewhere herein.

In some embodiments, IO operations are processed in the hosts 101 utilizing their respective instances of path selection logic 114 in the following manner. A given one of the hosts 101 establishes a plurality of paths between at least one initiator of the given host and a plurality of targets of respective storage nodes 105 of the distributed storage system 102. For each of a plurality of IO operations generated in the given host for delivery to the distributed storage system 102, the host selects a path to a particular target, and sends the IO operation to the corresponding storage node over the selected path.

The given host above is an example of what is more generally referred to herein as “at least one processing device” that includes a processor coupled to a memory. The storage nodes 105 of the distributed storage system 102 are also examples of “at least one processing device” as that term is broadly used herein.

It is to be appreciated that path selection as disclosed herein can be performed independently by each of the hosts 101, illustratively utilizing their respective instances of path selection logic 114, as indicated above, with possible involvement of additional or alternative system components.

In some embodiments, the initiator of the given host and the targets of the respective storage nodes 105 are configured to support one or more designated standard storage access protocols, such as an NVMe access protocol or a SCSI access protocol. As more particular examples in the NVMe context, the designated storage access protocol utilized in some embodiments may comprise an NVMe-oF, NVMe/TCP or NVMe/FC access protocol, although a wide variety of additional or alternative storage access protocols can be used in other embodiments.

The hosts 101 can comprise additional or alternative components. For example, in some embodiments, the hosts 101 further comprise respective sets of IO queues and respective multi-path input-output (MPIO) drivers. The MPIO drivers collectively comprise a multi-path layer of the hosts 101. Path selection functionality for delivery of IO operations from the hosts 101 to the distributed storage system 102 is provided in the multi-path layer by respective instances of path selection logic 114 implemented within the MPIO drivers. In some embodiments, the instances of path selection logic 114 are implemented at least in part within the MPIO drivers of the hosts 101.

The MPIO drivers may comprise, for example, otherwise conventional MPIO drivers, such as PowerPath® drivers from Dell Technologies, suitably modified in the manner disclosed herein to provide one or more portions of the disclosed functionality for adaptive IO connectivity. Other types of MPIO drivers from other driver vendors may be suitably modified to incorporate one or more portions of the functionality for adaptive IO connectivity as disclosed herein.

For example, the instances of path selection logic 114 of the respective hosts 101 can be implemented at least in part in respective MPIO drivers of those hosts.

In some embodiments, such instances of path selection logic 114 include or are otherwise associated with respective corresponding instances of host-side IO processing logic that are configured to receive, for a plurality of targets of the distributed storage system 102, corresponding discovery log pages, to extract from the received discovery log pages respective IP addresses for respective ones of the targets, and to control path selection for delivery of IO operations from a corresponding one of the hosts 101 to the targets based at least in part on the extracted IP addresses of the respective targets.

Such host-side IO processing logic can be part of an MPIO layer of the hosts 101, and possibly deployed at least in part within a corresponding instance of path selection logic 114 in the MPIO layer, or can be implemented elsewhere within the hosts 101.

In some embodiments, the hosts 101 comprise respective local caches, implemented using respective memories of those hosts. A given such local cache can be implemented using one or more cache cards. A wide variety of different caching techniques can be used in other embodiments, as will be appreciated by those skilled in the art. Other examples of memories of the respective hosts 101 that may be utilized to provide local caches include one or more memory cards or other memory devices, such as, for example, an NVMe over PCIe cache card, a local flash drive or other type of NVM storage drive, or combinations of these and other host memory devices.

The MPIO drivers are illustratively configured to deliver IO operations selected from their respective sets of IO queues to the distributed storage system 102 via selected ones of multiple paths over the network 104. The sources of the IO operations stored in the sets of IO queues illustratively include respective processes of one or more applications executing on the hosts 101. For example, IO operations can be generated by each of multiple processes of a database application running on one or more of the hosts 101. Such processes issue IO operations for delivery to the distributed storage system 102 over the network 104. Other types of sources of IO operations may be present in a given implementation of system 100.

A given IO operation is therefore illustratively generated by a process of an application running on a given one of the hosts 101, and is queued in one of the IO queues of the given host with other operations generated by other processes of that application, and possibly other processes of other applications.

The paths from the given host to the distributed storage system 102 illustratively comprise paths associated with respective initiator-target pairs, with each initiator comprising, for example, a port of a single-port or multi-port host bus adaptor (HBA) or other initiating entity of the given host and each target comprising a port or other targeted entity corresponding to one or more of the storage devices 106 of the distributed storage system 102. As noted above, the storage devices 106 illustratively comprise LUNs or other types of logical storage devices.

In some embodiments, the paths are associated with respective communication links between the given host and the distributed storage system 102 with each such communication link having a negotiated link speed. For example, in conjunction with registration of a given HBA to a switch of the network 104, the HBA and the switch may negotiate a link speed. The actual link speed that can be achieved in practice in some cases is less than the negotiated link speed, which is a theoretical maximum value.

Negotiated rates of the respective particular initiator and the corresponding target illustratively comprise respective negotiated data rates determined by execution of at least one link negotiation protocol for an associated one of the paths.

In some embodiments, at least a portion of the initiators comprise virtual initiators, such as, for example, respective ones of a plurality of N-Port ID Virtualization (NPIV) initiators associated with one or more Fibre Channel (FC) network connections. Such initiators illustratively utilize NVMe arrangements such as NVMe/FC, although other protocols can be used. Other embodiments can utilize other types of virtual initiators in which multiple network addresses can be supported by a single network interface, such as, for example, multiple media access control (MAC) addresses on a single network interface of an Ethernet network interface card (NIC). Accordingly, in some embodiments, the multiple virtual initiators are identified by respective ones of a plurality of media MAC addresses of a single network interface of a NIC. Such initiators illustratively utilize NVMe arrangements such as NVMe/TCP, although again other protocols can be used.

Accordingly, in some embodiments, multiple virtual initiators are associated with a single HBA of a given one of the hosts 101 but have respective unique identifiers associated therewith. Additionally or alternatively, different ones of the multiple virtual initiators are illustratively associated with respective different ones of a plurality of virtual machines of the given host that share a single HBA of the given host, or a plurality of logical partitions of the given host that share a single HBA of the given host.

Numerous alternative virtual initiator arrangements are possible, as will be apparent to those skilled in the art. The term “virtual initiator” as used herein is therefore intended to be broadly construed. It is also to be appreciated that other embodiments need not utilize any virtual initiators. References herein to the term “initiators” are intended to be broadly construed, and should therefore be understood to encompass physical initiators, virtual initiators, or combinations of both physical and virtual initiators.

Various scheduling algorithms, load balancing algorithms and/or other types of algorithms can be utilized by the MPIO driver of the given host in delivering IO operations from the IO queues of that host to the distributed storage system 102 over particular paths via the network 104. Each such IO operation is assumed to comprise one or more commands for instructing the distributed storage system 102 to perform particular types of storage-related functions such as reading data from or writing data to particular logical volumes of the distributed storage system 102. Such commands are assumed to have various payload sizes associated therewith, and the payload associated with a given command is referred to herein as its “command payload.”

A command directed by the given host to the distributed storage system 102 is considered an “outstanding” command until such time as its execution is completed in the viewpoint of the given host, at which time it is considered a “completed” command. The commands illustratively comprise respective NVMe commands, although other command formats, such as SCSI command formats, can be used in other embodiments. In the SCSI context, a given such command is illustratively defined by a corresponding command descriptor block (CDB) or similar format construct. The given command can have multiple blocks of payload associated therewith, such as a particular number of 512-byte SCSI blocks or other types of blocks. Other command formats, e.g., Submission Queue Entry (SQE), are utilized in the NVMe context.

In illustrative embodiments to be described below, it is assumed without limitation that the initiators of a plurality of initiator-target pairs comprise respective ports of the given host and that the targets of the plurality of initiator-target pairs comprise respective ports of the distributed storage system 102. The host ports can comprise, for example, ports of single-port HBAs and/or ports of multi-port HBAs, or other types of host ports, including network interface cards (NICs). A wide variety of other types and arrangements of initiators and targets can be used in other embodiments.

Selecting a particular one of multiple available paths for delivery of a selected one of the IO operations from the given host is more generally referred to herein as “path selection.” Path selection as that term is broadly used herein can in some cases involve both selection of a particular IO operation and selection of one of multiple possible paths for accessing a corresponding logical device of the distributed storage system 102. The corresponding logical device illustratively comprises a LUN or other logical storage volume to which the particular IO operation is directed. It should be noted that paths may be added or deleted between the hosts 101 and the distributed storage system 102 in the system 100. For example, the addition of one or more new paths from the given host to the distributed storage system 102 or the deletion of one or more existing paths from the given host to the distributed storage system 102 may result from respective addition or deletion of at least a portion of the storage devices 106 of the distributed storage system 102.

Addition or deletion of paths can also occur as a result of zoning and masking changes or other types of storage system reconfigurations performed by a storage administrator or other user. Some embodiments are configured to send a predetermined command from the given host to the distributed storage system 102, illustratively utilizing the MPIO driver, to determine if zoning and masking information has been changed. The predetermined command can comprise, for example, a log sense command, a mode sense command, a “vendor unique command” or VU command, or combinations of multiple instances of these or other commands, in an otherwise standardized command format.

In some embodiments, paths are added or deleted in conjunction with addition of a new storage array or deletion of an existing storage array from a storage system that includes multiple storage arrays, possibly in conjunction with configuration of the storage system for at least one of a migration operation and a replication operation.

For example, a storage system may include first and second storage arrays, with data being migrated from the first storage array to the second storage array prior to removing the first storage array from the storage system.

As another example, a storage system may include a production storage array and a recovery storage array, with data being replicated from the production storage array to the recovery storage array so as to be available for data recovery in the event of a failure involving the production storage array.

In these and other situations, path discovery scans may be repeated as needed in order to discover the addition of new paths or the deletion of existing paths.

A given path discovery scan can be performed utilizing known functionality of conventional MPIO drivers, such as PowerPath® drivers.

The path discovery scan in some embodiments may be further configured to identify one or more new LUNs or other logical storage volumes associated with the one or more new paths identified in the path discovery scan. The path discovery scan may comprise, for example, one or more bus scans which are configured to discover the appearance of any new LUNs that have been added to the distributed storage system 102 as well to discover the disappearance of any existing LUNs that have been deleted from the distributed storage system 102.

The MPIO driver of the given host in some embodiments comprises a user-space portion and a kernel-space portion. The kernel-space portion of the MPIO driver may be configured to detect one or more path changes of the type mentioned above, and to instruct the user-space portion of the MPIO driver to run a path discovery scan responsive to the detected path changes. Other divisions of functionality between the user-space portion and the kernel-space portion of the MPIO driver are possible. The user-space portion of the MPIO driver is illustratively associated with an Operating System (OS) kernel of the given host.

For each of one or more new paths identified in the path discovery scan, the given host may be configured to execute a host registration operation for that path. The host registration operation for a given new path illustratively provides notification to the distributed storage system 102 that the given host has discovered the new path.

As indicated previously, the storage nodes 105 of the distributed storage system 102 process IO operations from one or more hosts 101 and in processing those IO operations run various storage application processes that generally involve interaction of that storage node with one or more other ones of the storage nodes.

In the FIG. 1 embodiment, the distributed storage system 102 comprises storage processors 108 and corresponding sets of storage devices 106, and may include additional or alternative components, such as sets of local caches.

The storage processors 108 illustratively control the processing of IO operations received in the distributed storage system 102 from the hosts 101. For example, the storage processors 108 illustratively manage the processing of read and write commands directed by the MPIO drivers of the hosts 101 to particular ones of the storage devices 106. The storage processors 108 can be implemented as respective storage controllers, directors or other storage system components configured to control storage system operations relating to processing of IO operations. In some embodiments, each of the storage processors 108 has a different one of the above-noted local caches associated therewith, although numerous alternative arrangements are possible.

The manner in which functionality for adaptive IO connectivity is implemented in system 100 in some embodiments, utilizing multiple clusters of storage nodes 105 and corresponding cluster metadata managers 112, will now be described in more detail.

As indicated previously, in software-defined storage system arrangements utilizing advanced storage access protocols such as NVMe-oF or NVMe/TCP, and in numerous other distributed storage system contexts, it can be unduly difficult to perform load balancing across targets of the storage nodes. For example, conventional approaches can lead to sub-optimal arrangements in terms of load balancing of IO operations across storage targets of different clusters, particularly in conjunction with data services such as replication, migration and/or copying, thereby adversely impacting storage system performance.

Illustrative embodiments disclosed herein provide techniques for adaptive IO connectivity based on storage target processing load, in a software-defined storage system or other type of storage system comprising multiple clusters of storage nodes. Such techniques can advantageously facilitate determination of storage target utilization across multiple clusters, particularly in certain storage contexts such as those involving data services carried out between source and target clusters. For example, some embodiments utilize the disclosed techniques to provide enhanced load balancing in delivery of IO operations from a source cluster to a target cluster as part of a data service, such as replication, migration or copying of one or more logical storage volumes, carried out between the source and target clusters. These and other embodiments can significantly improve storage system performance.

The above-noted adaptive IO connectivity in some embodiments is illustratively implemented in the following manner. It is assumed for purposes of illustration only that the distributed storage system 102 comprises at least first and second clusters of the storage nodes 105. Each such cluster illustratively comprises a different subset of the storage nodes 105, and is managed at least in part by a corresponding one of the cluster metadata managers 112. The first and second clusters may comprise respective local and remote clusters of storage nodes in a distributed storage system. The first and second clusters, also more generally referred to herein as first and second storage systems, each include multiple storage targets, also referred to herein as simply “targets,” that are utilized in processing IO operations received from one or more of the hosts 101 and/or processing IO operations associated with one or more data services carried out between the first and second clusters.

At least one processing device of the system 100, which may comprise, for example, at least one processing device implementing at least one of the cluster metadata managers 112 and/or at least one processing device implementing at least a portion of the distributed storage system 102, is configured to obtain, for a first storage system, information characterizing IO processing loads of respective storage targets of a second storage system, and to configure a data service involving transfer of data from the first storage system to the second storage system based at least in part on the obtained information, wherein configuring the data service comprises selecting a particular subset of the storage targets of the second storage system for use in implementing the data service based at least in part on the obtained information.

The first and second storage systems in some embodiments comprise respective first and second distinct clusters of the storage nodes 105 of the distributed storage system 102, such as respective source and target clusters of a data service, which may comprise, for example, a replication service, a migration service and/or a copying service. Additional or alternative types of data services, in any combination, may be used. Storage targets are illustratively configurable to handle such data services in addition to or in place of handling IO operations that originate from one or more host devices.

In some embodiments, a given one of the storage targets of the second storage system comprises at least one NVMe controller of the second storage system, although other types of storage targets can be used, in any combination. The storage targets in some embodiments therefore illustratively comprise respective NVMe targets, each of which may comprise one or more NVMe controllers of the second storage system. The NVMe targets store data of a plurality of logical storage volumes illustratively comprising respective NVMe namespaces. Other types of storage targets and logical storage volumes can be used in other embodiments.

Each of one or more of the storage targets of the second storage system in some embodiments is configured to operate both as a data mobility interface to handle IO operations generated as part of one or more data services and as a host-storage interface to handle IO operations received in the storage target from one or more of the hosts 101. In such an arrangement, the IO processing loads of the respective storage targets of the second storage system illustratively include processing of IO operations received in the storage targets from the one or more hosts 101.

In some embodiments, configuring the data service further comprises establishing connectivity to the selected subset of the storage targets of the second storage system in conjunction with initiation of the data service.

Additionally or alternatively, selecting a particular subset of the storage targets of the second storage system for use in implementing the data service based at least in part on the obtained information in some embodiments comprises selecting a least-loaded subset of the storage targets of the second storage system for use in implementing the data service. Other selection criteria may be used in other embodiments.

In some embodiments, at least the obtaining of the information characterizing IO processing loads of respective storage targets of a second storage system is performed in a first one of the cluster metadata managers 112. The first cluster metadata manager is associated with the first storage system. The first cluster metadata manager associated with the first storage system may be configured to obtain the information from a second one of the cluster metadata managers 112 that is associated with the second storage system.

The selected subset of the storage targets of the second storage system that is used in implementing the data service in some embodiments is adaptively varied over time in response to one or more changes in the IO processing loads of the respective storage targets of the second storage system. For example, the above-noted obtaining, for the first storage system, of the information characterizing IO processing loads of respective storage targets of the second storage system is illustratively repeated over time, periodically or under other specified conditions, and different subsets of the storage targets of the second storage system may be dynamically selected for use in implementing the data service based at least in part on the obtained information, such that different subsets of the storage targets of the second storage system are used in implementing the data service over time, based at least in part on changes in processing loads of those storage targets over time, as reflected in the obtained information.

Additionally or alternatively, obtaining the information characterizing IO processing loads of respective storage targets of the second storage system in some embodiments comprises obtaining the information from discovery log pages that are reported by only those of the storage targets having IO processing loads below a designated threshold. For example, the storage targets and/or other target discovery components of the system 100 can be configured to report IP addresses and other related information for only those of the storage targets that have IO processing loads below the designated threshold.

In some embodiments, a host receives, for each of multiple targets of a storage system, corresponding discovery log pages, illustratively from one or more discovery controllers which in some embodiments are implemented on one or more of the multiple targets and/or on at least one different target that is not part of the multiple targets, although other arrangements are possible. In some embodiments, the discovery log pages are illustratively obtained using commands of a storage access protocol, such as an NVMe access protocol, including NVMe-oF or NVMe/TCP, although the disclosed techniques are applicable for use with other storage access protocols, including SCSI and iSCSI access protocols. The term “discovery log page” as used herein is therefore intended to be broadly construed, as illustratively comprising, for example, at least one log page or a suitable portion thereof that includes one or more entries comprising information utilized by the host to discover and connect to the corresponding target, and should not be viewed as being limited to a particular type of log page configured in accordance with a particular storage access protocol.

Additional aspects of some illustrative embodiments will now be described.

As mentioned above, each of the storage nodes 105 of the distributed storage system 102 illustratively comprises one or more targets, where each such target is associated with multiple distinct paths from respective HBAs or other initiators of one or more of the hosts 101.

For example, in some embodiments, one or more of the storage nodes 105 each implements at least one target, such as an NVMe target, that is configured to include multiple controllers, such as at least a first controller associated with a first storage pool, and a second controller associated with a second storage pool. The first and second storage pools are illustratively storage pools of the distributed storage system 102, and such storage pools may be distributed across multiple ones of the storage nodes 105. Each of the first and second storage pools is assumed to comprise one or more LUNs or other logical storage volumes.

Although first and second controllers are referred to in conjunction with some embodiments herein, it is to be appreciated that more than two controllers can be implemented in a given target in order to support more than two storage pools.

A given one of the storage nodes 105 illustratively processes IO operations received from one or more of the hosts 101, with different ones of the IO operations being directed by the one or more hosts 101 from one or more initiators of the one or more hosts 101 to different ones of the first and second controllers of the target implemented within the given storage node.

In some embodiments, each of the IO queues configured in the distributed storage system 102 for the given target is associated with a corresponding different TCP connection between the given host and the given target.

The given target may comprise at least one NVMe controller of a particular one of the storage nodes 105 of the distributed storage system 102, although other types of targets can be used.

The term “target” as used herein in the context of a distributed storage system or other type of storage system is intended to be broadly construed.

The target in some embodiments more particularly comprises multiple controllers accessible via respective different associations comprising one or more TCP connections between the given host and the given storage node. For example, the target may comprise a plurality of NVMe controllers of an NVMe subsystem of the given storage node.

In some embodiments, an NVMe target illustratively comprises one or more NVMe controllers, each having a set of TCP connections associated with an administrative (“Admin”) queue and one or more IO queues. Each TCP connection illustratively corresponds to a single queue having associated request/response entries. In some embodiments, the TCP connections corresponding to a given Admin queue and a set of one or more IO queues are collectively referred to as a “TCP association.” Typically, a fixed number of IO queues are established, with a corresponding fixed number of TCP connections, in accordance with maximum load requirements of one or more applications that will be directing IO operations to the NVMe target for processing. The IO queues and their corresponding TCP connections are examples of what are more generally referred to herein as “network resources.” Such network resources in some embodiments are illustratively used to receive IO operations directed to targets of a storage system from initiators of one or more host devices. Additional or alternative network resources can be used in other embodiments.

As indicated above, in some embodiments, multiple controllers are part of a single physical controller subsystem of the given storage node. For example, first and second controllers may comprise respective NVMe controllers of an NVMe subsystem of the given storage node. Such an NVMe subsystem is considered an example of what is more generally referred to herein as a “target” of the given storage node.

The first and second controllers in some embodiments may be viewed as comprising respective “virtual” controllers associated with the single physical controller subsystem of the given storage node.

Additionally or alternatively, the first and second controllers in some embodiments are accessible via respective first and second different associations comprising one or more TCP connections between a given one of the one or more hosts 101 and the given storage node. In such an arrangement, a host accesses the first controller using the first association, and accesses the second controller using the second association. Such associations are also referred to herein as TCP associations, and may include, for each of at least one Admin queue and a plurality of IO queues, a corresponding TCP connection. Other types of communication links can be used in other embodiments.

In some embodiments, the first controller comprises a first set of IO queues and the second controller comprises a second set of IO queues, for use in processing IO operations for their respective storage pools. Again, each IO queue in a given such set of IO queues may be associated with a separate TCP connection over which a given one of the hosts 101 communicates with the corresponding controller.

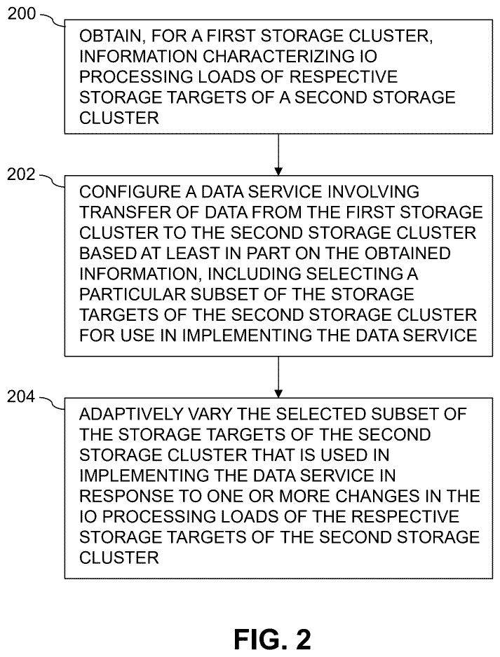

An additional example of an illustrative process for implementing at least some of the above-described adaptive IO connectivity functionality will be provided below in conjunction with the flow diagram of FIG. 2.

As indicated previously, the storage nodes 105 collectively comprise an example of a distributed storage system. The term “distributed storage system” as used herein is intended to be broadly construed, so as to encompass, for example, scale-out storage systems, clustered storage systems or other types of storage systems distributed over multiple storage nodes, including combinations of multiple storage clusters.

Also, the term “storage volume” as used herein is intended to be broadly construed, and should not be viewed as being limited to any particular format or configuration, such as namespaces or LUNs.

The storage nodes 105 of the example distributed storage system 102 illustrated in FIG. 1 are assumed to be implemented using at least one processing platform, with each such processing platform comprising one or more processing devices, and each such processing device comprising a processor coupled to a memory. Such processing devices can illustratively include particular arrangements of compute, storage and network resources.

The storage nodes 105 may be implemented on respective distinct processing platforms, although numerous other arrangements are possible. At least portions of their associated hosts 101 may be implemented on the same processing platforms as the storage nodes 105 or on separate processing platforms.

The term “processing platform” as used herein is intended to be broadly construed so as to encompass, by way of illustration and without limitation, multiple sets of processing devices and associated storage systems that are configured to communicate over one or more networks. For example, distributed implementations of the system 100 are possible, in which certain components of the system reside in one data center in a first geographic location while other components of the system reside in one or more other data centers in one or more other geographic locations that are potentially remote from the first geographic location. Thus, it is possible in some implementations of the system 100 for different subsets of the hosts 101 and the storage nodes 105 to reside in different data centers. Numerous other distributed implementations of the storage nodes 105 and their respective associated sets of hosts 101 are possible.

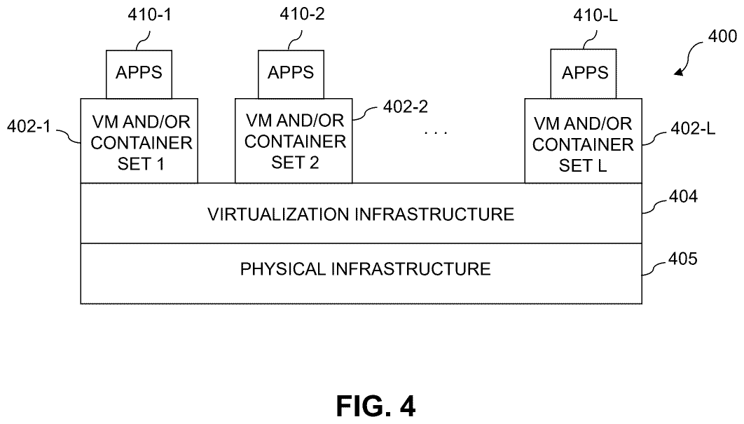

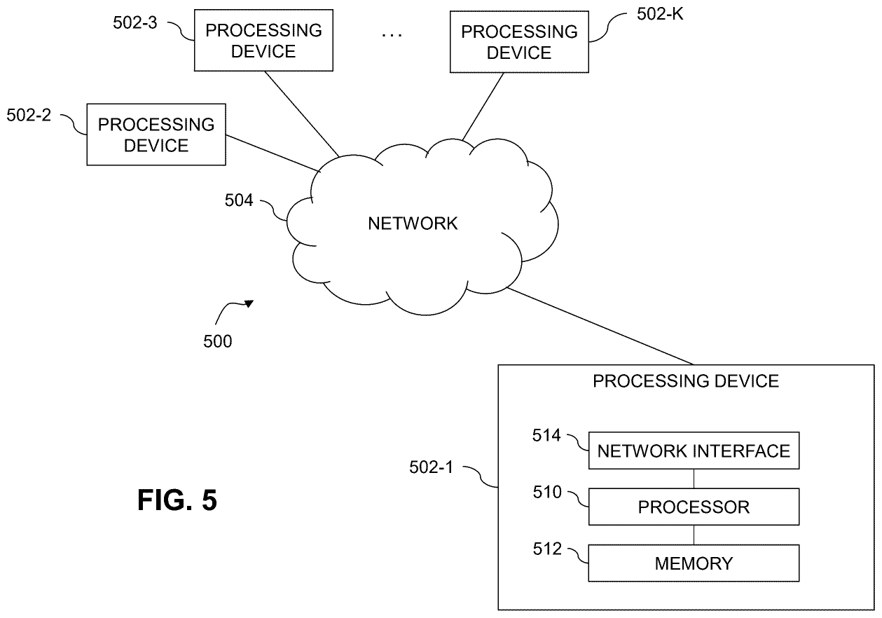

Additional examples of processing platforms utilized to implement storage systems and possibly their associated hosts in illustrative embodiments will be described in more detail below in conjunction with FIGS. 4 and 5.

It is to be appreciated that these and other features of illustrative embodiments are presented by way of example only, and should not be construed as limiting in any way.

The particular features described above in conjunction with FIG. 1 should therefore not be construed as limiting in any way, and a wide variety of other system arrangements implementing adaptive IO connectivity as disclosed herein are possible.

Accordingly, different numbers, types and arrangements of system components such as hosts 101, distributed storage system 102, storage nodes 105, storage devices 106, storage processors 108, system management nodes 110, cluster metadata managers 112, path selection logic 114 and system management database 116 can be used in other embodiments. For example, as mentioned previously, system management functionality of the cluster metadata managers 112 of the system management nodes 110 can be distributed across a subset of the storage nodes 105, instead of being implemented on separate nodes.

It should therefore be understood that the particular sets of modules and other components implemented in a distributed storage system as illustrated in FIG. 1 are presented by way of example only. In other embodiments, only subsets of these components, or additional or alternative sets of components, may be used, and such components may exhibit alternative functionality and configurations.

For example, in other embodiments, certain portions of adaptive IO connectivity functionality as disclosed herein can be implemented in one or more hosts, in a storage system, or partially in a host and partially in a storage system. Accordingly, illustrative embodiments are not limited to arrangements in which adaptive IO connectivity functionality is implemented primarily in storage system or primarily in a particular host or set of hosts, and therefore such embodiments encompass various alternative arrangements, such as, for example, an arrangement in which the functionality is distributed over one or more storage systems and one or more associated hosts, each comprising one or more processing devices, and possibly involving one or more separate management nodes. The term “at least one processing device” as used herein is therefore intended to be broadly construed.

The operation of the information processing system 100 will now be described in further detail with reference to the flow diagram of the illustrative embodiment of FIG. 2, which illustrates a process for adaptive IO connectivity as disclosed herein. This process may be viewed as an example algorithm implemented at least in part by distributed storage system 102 interacting with one or more of the hosts 101 and one or more of the system management nodes 110. These and other algorithms for adaptive IO connectivity as disclosed herein can be implemented using other types and arrangements of system components in other embodiments.

The process illustrated in FIG. 2 includes steps 200 through 204, and in some implementations may be performed primarily by at least one of the cluster metadata managers 112 of at least one of the system management nodes 110 interacting with at least a subset of the storage nodes 105 of the distributed storage system 102. Similar processes or aspects of a given such process may be performed primarily by other ones of the cluster metadata managers 112 of other ones of the system management nodes 110 interacting with respective other subsets of the storage nodes 105, although it is to be appreciated that numerous other implementations are possible in other embodiments.

In step 200, a first cluster metadata manager obtains, for a first storage cluster, information characterizing IO processing loads of respective storage targets of a second storage cluster. The first storage cluster illustratively comprises a first subset of the storage nodes 105 of the distributed storage system 102, the second storage cluster illustratively comprises a second subset of the storage nodes 105 of the distributed storage system 102, and the first cluster metadata manager comprises a first one of the cluster metadata managers 112. The first cluster metadata manager associated with the first storage cluster is illustratively configured to obtain the information from a second cluster metadata manager associated with the second storage cluster, although the information can be obtained in additional or alternative ways in other embodiments.

As indicated elsewhere herein, the term “storage target” as used herein is also intended to be broadly construed, and in some embodiments can comprise, for example, an NVMe subsystem, which is more generally referred to herein as an NVMe target. The NVMe subsystem or other NVMe target in such an arrangement illustratively comprises one or more controllers. In some embodiments, each IO queue has its own separate TCP connection, although other arrangements can be used. The set of TCP connections utilized for respective ones of the IO queues and a corresponding Admin queue of the given target are collectively referred to herein as a “TCP association.” The IO queues and their associated TCP connections are examples of what are more generally referred to herein as “network resources,” and other types of network resources can be used in other embodiments.

In step 202, a data service involving transfer of data from the first storage cluster to the second storage cluster is configured based at least in part on the obtained information. This illustratively includes selecting a particular subset of the storage targets of the second storage cluster for use in implementing the data service. The data service may comprise, for example, at least one of a replication service, a migration service and a copying service, carried out between the first and second storage clusters. In some embodiments, selecting a particular subset of the storage targets of the second storage system for use in implementing the data service based at least in part on the obtained information comprises selecting a least-loaded subset of the storage targets of the second storage system for use in implementing the data service, although additional or alternative storage target subset selection criteria may be used in other embodiments. In some embodiments, configuring the data service further comprises establishing connectivity to the selected subset of the storage targets of the second storage system in conjunction with initiation of the data service.

In step 204, the selected subset of the storage targets of the second storage cluster that is used in implementing the data service is adaptively varied in response to one or more changes in the IO processing loads of the respective storage targets of the second storage cluster.

One or more of steps 200 through 204 are illustratively repeated over time in order to support the adaptive IO connectivity functionality disclosed herein. Multiple such processes may operate in parallel with one another in order to provide adaptive IO connectivity functionality for different clusters using their corresponding respective storage nodes, storage targets and cluster metadata managers.

The steps of the FIG. 2 process are shown in sequential order for clarity and simplicity of illustration only, and certain steps can at least partially overlap with other steps. Additional or alternative steps can be used in other embodiments.

The particular processing operations and other system functionality described in conjunction with the flow diagram of FIG. 2 are therefore presented by way of illustrative example only, and should not be construed as limiting the scope of the disclosure in any way. Alternative embodiments can use other types of processing operations for implementing adaptive IO connectivity for one or more hosts and a storage system. For example, as indicated above, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement a plurality of different processes for respective different clusters and/or data services.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

One or more hosts and/or one or more storage nodes can be implemented as part of what is more generally referred to herein as a processing platform comprising one or more processing devices each comprising a processor coupled to a memory.

A given such processing device in some embodiments may correspond to one or more virtual machines or other types of virtualization infrastructure such as Docker containers or Linux containers (LXCs). Hosts, storage processors and other system components may be implemented at least in part using processing devices of such processing platforms. For example, respective path selection logic instances and other related logic instances of the hosts can be implemented in respective containers running on respective ones of the processing devices of a processing platform.

Referring now to FIG. 3, an additional example of an information processing system 300 implementing functionality for adaptive IO connectivity is shown. The system 300 comprises a plurality of host devices 301, and first and second storage clusters more particularly comprising a source cluster 302S and a target cluster 302T, also referred to herein as respective local and remote clusters, each of which is assumed to comprise multiple storage nodes each with one or more storage targets. The system 300 is assumed to be a software-defined storage system, also referred to herein as an SDS system, and the storage targets in this embodiment are more particularly denoted as storage data targets (SDTs) as illustrated. The source cluster 302S includes as its storage targets a set of six SDTs denoted SDT1 through SDT6. The target cluster 302T includes as its storage targets a set of ten SDTs denoted SDT1 through SDT10. The host devices 301 and the source and target clusters 302S and 302T communicate with one another over a TCP/IP network 304. Also coupled to the network 304 are a metadata manager (MDM) 312S of the source cluster 302S, and an MDM 312T of the target cluster 302T. Other embodiments can include additional clusters, host devices and cluster metadata managers and/or other processing device based system components.

It is assumed that applications execute on the host devices 301 and generate IO operations that are delivered over the network 304 to particular SDTs of the target cluster 302T, as illustrated by the dashed lines between the host devices 301 and the SDTs denoted SDT1 and SDT4 of the target cluster 302T.

It is further assumed that each of one or more of the storage targets of the target cluster 302T is configured to operate both as a data mobility interface to handle IO operations generated as part of one or more data services initiated by the source cluster 302S, and as a host-storage interface to handle IO operations received in the storage target from the host devices 301. Accordingly, the IO processing loads of the respective storage targets of the target cluster 302T include processing of IO operations received in the one or more of its storage targets from the host devices 301.

In some embodiments, the storage nodes of the source cluster 302S and the target cluster 302T are configured at least in part as respective clusters of PowerFlex™ software-defined storage nodes from Dell Technologies, suitably modified as disclosed herein to implement functionality for adaptive IO connectivity, although it is to be appreciated that other types of storage nodes can be used in other embodiments.

The source cluster 302S and target cluster 302T collectively provide a distributed storage system based on the NVMe access protocol. The clusters comprise multiple NVMe targets, illustratively implemented as respective SDTs, each providing a different storage system interface. Application servers or other host devices can connect to several of the NVMe targets for IO load balancing, bandwidth utilization and congestion avoidance, illustratively utilizing path selection algorithms implemented in MPIO drivers of the type noted above. Moreover, one or more of the SDTs are additionally configured for use as data mobility interfaces to handle IO operations generated as part of one or more data services.

In some embodiments, in order to utilize NVMe-OF technology, SDTs are configured on respective storage nodes of the system 300, which comprises software-defined storage and is therefore referred to herein as an SDS system. A given such SDT generally acts as a frontend for its corresponding storage node, providing a host-storage interface to backend storage on that node, and handles functionality such as IO processing and connection discovery services for NVMe hosts configured within the SDS system. Some SDTs can additionally or alternatively be utilized in other use cases such as data mobility (e.g., replication, migration, data copy, etc.), where SDTs in the source cluster of the SDS system make IO connections to SDTs in a remote cluster, also referred to as a target cluster of the SDS system, and use those IO connections to copy data from the source cluster to the target cluster in the SDS system. An SDT can therefore have multiple interfaces and each interface can take one or multiple roles (e.g., host-storage interface and data mobility interface) based on user configuration.

In these and other contexts involving SDS systems with SDTs configured on respective storage nodes, problems can arise when existing remote SDTs, which are configured for the host-storage interface role and are currently handling NVMe host traffic on a target cluster of an SDS system, are also configured for the data mobility interface role, and a user-space initiator associated with the source cluster does not account for the current load from NVMe host IO traffic on the remote SDTs. For example, absent use of the techniques disclosed herein, a user-space initiator associated with the source cluster illustratively proceeds with establishing new IO connections from one or more source cluster SDTs to one or more target cluster SDTs for implementing data mobility workloads, such as replication workloads for replicating data from the source cluster to the remote cluster, without knowing whether or which remote SDTs may already be handling heavy host-driven IO processing loads. This lack of awareness of the existing NVMe host IO traffic load on the SDTs of the target cluster leads to an imbalance in the distribution of workload across all SDTs in the target cluster of the SDS system.

As a more particular example, consider an illustrative arrangement involving the two SDS clusters shown in FIG. 3, namely, the source cluster 302S and the target cluster 302T, each comprising multiple storage nodes, and with each such storage node including multiple SDTs. As indicated previously, the target cluster 302T comprises 10 SDTs, and it is assumed that each of these ten SDTs is assigned multiple roles, namely, both a host-storage interface role and a data mobility interface role. Accordingly, the source cluster may utilize any or all of those remote SDTs that have data mobility interface roles in implementing a given data service. For example, the source cluster 302S may attempt to establish a data service using SDT1 through SDT6 of the source cluster 302S and SDT1 through SDT10 of the target cluster 302T.

Some of the remote SDTs, illustratively two of the ten SDTs of the target cluster 302T, namely SDT1 and SDT4 as highlighted in the figure, more particularly function as respective NVMe TCP controllers for the host devices 301, illustratively provisioning one or more logical storage volumes to NVMe initiators on the host devices 301. The IO processing load on these two SDTs, which are acting as NVMe controllers for the host devices 301, can fluctuate over time based on the IO demand from the host devices 301 and the number of connections established by the host devices 301 to the two SDTs.

When these same two SDTs are also used for data mobility workloads of a data service carried out between the source cluster 302S and the target cluster 302T, the user-space initiator associated with the source cluster 302S establishes distributed IO connections with the SDTs on the remote side. However, absent use of the techniques disclosed herein, the user-space initiator lacks visibility into the IO processing loads on the respective remote SDTs and may initiate connections even with those two SDTs which may already be handling significant NVMe traffic from the host devices 301. As a result, the SDTs on the source cluster 302S, unaware of the remote-side NVMe host IO traffic load, may inadvertently overload those particular SDTs at the remote cluster, negatively impacting overall performance.

Illustrative embodiments provide technical solutions to such problems, in a manner that improves load balancing and resiliency across the multiple clusters of the SDS system, leading to improved overall performance.

As indicated above, the example SDS system shown in FIG. 3 is configured to include MDM 312S associated with source cluster 302S and MDM 312T associated with target cluster 302T. Each such MDM is illustratively implemented utilizing one or more management nodes of the SDS system. Alternatively, the MDM functionality can be incorporated at least in part into one or more of the storage nodes of its corresponding cluster. The MDM of a given cluster in some embodiments illustratively collects and monitors resource utilization statistics for each SDT in the SDS system, illustratively at least in part by communicating with the SDTs of its own cluster and/or communicating with another MDM of another cluster, and these resource utilization statistics are utilized by the MDM and/or other components of the SDS system to make informed decisions when enabling additional data services such as replication or other data mobility services, which may include, for example, migration, data copying, etc. Such data services are referred to in some embodiments herein as “additional data services” as they are implemented in addition to any IO processing that is ordinarily performed for IOs received from one or more of the host devices 301.

In some embodiments, the MDM 312S of the source cluster 302S illustratively selects the least loaded SDTs from within the target cluster 302T to enable the additional data services to be carried out between the source and target clusters, where such information is obtained from the MDM 312T of the target cluster 302T, such that the additional data services do not impact the existing load on the more heavily loaded SDTs of the target cluster 302T, and the objectives of the additional data services can be more efficiently attained.

In some embodiments, a user-space initiator associated with the source cluster 302S utilizes information provided by the MDM 312S of the source cluster 302S to establish and modify remote IO connections to the SDTs of the target cluster 302T by understanding actual resource utilization at the SDTs of the target cluster 302T, thereby avoiding the potential overload conditions that were described previously. Such obtained information in some embodiments is not just utilized for making initial connectivity decisions, but can additionally be repeatedly updated and used to continuously monitor and effectively modify IO connections dynamically over time to maintain optimal overall performance in the SDS system.

It should be noted that references herein to “user-space initiators” are presented by way of example only, and numerous other types of initiators could be used in these and other embodiments, as further described elsewhere herein.

In some embodiments, details regarding the least loaded remote SDTs are provided to the user-space initiator associated with the source cluster at least in part by the remote SDTs of the SDS system limiting the interface IP address discovery information that is provided to the user-space initiator via respective NVMe discovery log pages or other reporting mechanisms. For example, remote SDTs that are heavily loaded with host NVMe IO traffic in some embodiments will not have their IP address and other discovery details included in the one or more NVMe discovery log pages that are sent to the user-space initiators associated with the source cluster. Such an arrangement ensures that the user-space initiators on the source side will utilize only to the least loaded remote SDTs when initiating and maintaining connections for data mobility services carried out between the source and target clusters.

Additionally or alternatively, the MDM 312S of the source cluster 302S can dynamically assign additional data service roles relating to data mobility to particular remote SDTs based on the current levels of resource utilization of those SDTs, illustratively obtained through interaction with the MDM 312T of the target cluster 302T.

In some embodiments, each SDT and/or an associated external entity that may be part of the same storage node is illustratively configured to measure overall resource utilization, such as utilization of compute, memory and/or network resources for that particular SDT, at periodic intervals or under other conditions. This information is then pushed by the SDTs and/or the associated external entity to the MDM of the corresponding cluster for further processing. By way of example, the SDT and/or its associated external entity in some embodiments can report its current load conditions to the MDM of the corresponding cluster as a particular one of a plurality of load level indictors, such as LOW, MEDIUM or HIGH, or using other range parameters and/or definitions, at least some of which may be user configurable.

The MDM of a given cluster in some embodiments is configured to periodically collect and/or query resource utilization indicators from each SDT and/or associated external entity on each node of that cluster, and to maintain one or more data structures characterizing current workload at each SDT of that cluster. The one or more data structures in some embodiments can be utilized to generate a corresponding heat map of resource utilization across the SDTs of the cluster. At least portions of the information in the one or more data structures are provided to another MDM of another cluster in the SDS system.

In some embodiments, as part of an initial step involving the MDM of a source cluster facilitating configuration of a data service between the source cluster and the remote cluster of the SDS system, the MDM 312S of the source cluster determines from its peer MDM 312T of the target cluster 312T which of the SDTs of the target cluster 312T are the least loaded SDTs and enables the data service using those particular SDTs.

The source SDTs then establish IO connections to the remote cluster SDTs by connecting to IP addresses of the remote SDTs as published in one or more corresponding NVMe discovery log pages. In some embodiments, the remote cluster publishes such connection information for only those SDTs that are not already heavily loaded.

User-space initiators in the SDS system illustratively connect to a discovery controller on an NVMe target to obtain at least a portion of the NVMe discovery log pages. Additional or alternative techniques can be used to obtain discovery log pages in other embodiments. For example, one or more discovery controllers associated with a discovery service implemented at least in part on one or more NVMe subsystems or other NVMe targets can provide one or more of the discovery log pages in illustrative embodiments.

Additional details regarding NVMe discovery log pages and other aspects of the NVMe standard can be found in, for example, the above-cited NVM Express Base Specification, Revision 2.0c, October 2022, and its associated NVM Express Command Set Specification and NVM Express TCP Transport Specification, although other NVMe implementations can be used.

Some embodiments can alternatively involve enabling the data service using a single least loaded SDT of the remote cluster. For example, a single SDT of the source cluster can use a single SDT of the remote cluster to implement the data service. Accordingly, use of multiple SDTs on source and remotes sides for a given data service such as replication or another data mobility service in some embodiments herein is by way of example only, and should not be viewed as limiting in any way.

As a given data mobility session progresses between the source and remote clusters, it is possible that the loads of the originally-selected SDTs have changed, such that the SDT resource utilization data structure maintained by the MDM of a given cluster now indicates that different SDTs are now more lightly loaded than others.

This detected condition and/or other conditions can be used to trigger a rebalancing of the remote IO connections to make use of one or more different SDTs. Such a rebalancing can be achieved in some embodiments by the remote MDM dynamically assigning the data mobility interface role to the new least loaded SDT and updating the one or more NVMe discovery log pages with new IO connections. Once the source SDT successfully connects to the new remote SDTs, the old SDTs can be removed from the one or more NVMe discovery log pages thereby making changes gracefully without application downtime.

Again, it is to be appreciated that references in the above description to operations involving multiple SDTs in each of source and remote clusters can instead involve only one SDT at a time in each of at least one of the source and remote clusters. For example, a given replication operation or other data mobility service can be performed using a single source SDT communicating with the currently least loaded single remote SDT. Numerous other arrangements are possible in other embodiments.

Illustrative embodiments disclosed herein advantageously avoid the above-described problems that can result when source SDTs make IO connections with remote SDTs while unaware of SDT load of the remote SDTs.

Moreover, some embodiments allow the remote SDTs that are used by the source SDTs to be dynamically varied over time, as the load conditions on the remote SDTs change.

It is to be appreciated that the particular features and functionality described above are examples only.

Illustrative embodiments provide significant advantages over conventional practice. For example, these embodiments provide improved load balancing and resiliency, particularly across multiple clusters of storage nodes in a software-defined storage system or other type of distributed storage system.

Multi-pathing portions of the example techniques described above may be performed by a given MPIO driver on a corresponding host device, and similarly by other MPIO drivers on respective other host devices. Such MPIO drivers illustratively form a multi-path layer comprising multi-pathing software of the host devices. Other types of host drivers can be used in other embodiments.

Although particular software-defined storage system configurations are described in conjunction with the embodiments above, the disclosed techniques can be adapted in a straightforward manner for use in a wide variety of other types of storage systems. Accordingly, the disclosed techniques should not be viewed as being restricted in any way to particular storage systems, such as PowerFlex™ storage systems.

Also, storage access protocols other than SCSI and/or NVMe access protocols can be used in other embodiments.

It should also be understood that the particular features and functionality described above are examples only. Accordingly, the particular system configuration as shown in FIG. 3 is presented by way of illustrative example only, and should not be viewed as limiting in any way. A wide variety of different alternative arrangements of host devices, storage node clusters and metadata managers can be used in other embodiments.

For example, in some embodiments, an information processing system comprises host-side elements that include application processes, path selection logic and IO processing logic, and storage-side elements that include multiple storage targets and IO processing logic. The path selection logic is configured to operate in conjunction with the host-side IO processing logic, the multiple storage targets and the storage-side IO processing logic, and possibly additional components such as one or more cluster metadata managers of one or more system management nodes, to implement functionality for adaptive IO connectivity in the system in the manner disclosed herein. There may be separate instances of one or more such elements associated with each of a plurality of system components such as hosts and storage arrays of the system. For example, different instances of the path selection logic and host-side IO processing logic are illustratively implemented within or otherwise in association with respective ones of a plurality of MPIO drivers of respective hosts. In other embodiments, the host-side IO processing logic can be implemented at least in part within the path selection logic. Numerous other arrangements are possible.

The system in some embodiments may be configured in accordance with a layered system architecture that illustratively includes a host processor layer, an MPIO layer, a host port layer, a switch fabric layer, a storage array port layer and a storage array processor layer. The host processor layer, the MPIO layer and the host port layer are associated with one or more hosts, the switch fabric layer is associated with one or more SANs or other types of networks, and the storage array port layer and storage array processor layer are associated with one or more storage arrays. A given such storage array illustratively comprises a software-defined storage system or other type of distributed storage system comprising a plurality of storage nodes, and may be one of a plurality of clusters of the distributed storage system. In addition, as indicated above, one or more cluster metadata managers of one or more system management nodes may also be associated with such clusters, and configured to implement at least portions of the disclosed adaptive IO connectivity functionality.

In a manner similar to that described elsewhere herein, one or more storage arrays of the system are each configured to implement one or more storage targets, such as, for example, at least a first controller associated with a first storage pool, and a second controller associated with a second storage pool, where the first and second controllers each include respective sets of IO queues. Numerous other arrangements of multiple targets can be used.

The system in such an embodiment implements adaptive IO connectivity functionality utilizing one or more MPIO drivers of the MPIO layer, and associated instances of path selection logic and host-side IO processing logic, as well as the multiple storage targets and the storage-side IO processing logic, possibly with one or more cluster metadata managers associated with one or more management nodes. It should be noted in this regard that in some embodiments, functionality of a cluster metadata manager may be implemented at least in part within one or more storage nodes of a given storage cluster, instead of within one or more management nodes.

Although various types of commands and log pages are used in illustrative embodiments herein, other types of commands and log pages can be used in other embodiments. For example, various types of log sense, mode sense and/or other “read-like” commands, possibly including one or more commands of a standard storage access protocol such as the above-noted NVMe and SCSI access protocols, can be used in other embodiments to obtain in a source cluster information characterizing IO processing loads of remote storage targets.

These and other features of illustrative embodiments disclosed herein are examples only, and should not be construed as limiting in any way. Other types of adaptive IO connectivity can be used in other embodiments, and the term “adaptive IO connectivity” as used herein is intended to be broadly construed.

As indicated previously, the above-described illustrative embodiments can provide significant advantages over conventional approaches.

For example, some embodiments provide techniques for adaptive IO connectivity, in a software-defined storage system or other type of distributed storage system comprising multiple storage clusters. In some embodiments, adaptive IO connectivity is implemented at least in part by obtaining, for a first storage cluster, information characterizing IO processing loads of respective storage targets of a second storage cluster, and configuring a data service involving transfer of data from the first storage cluster to the second storage cluster based at least in part on the obtained information, including selecting a particular subset of the storage targets of the second storage cluster for use in implementing the data service based at least in part on the obtained information.

Such arrangements provide enhanced load balancing across the multiple storage clusters of the distributed storage system.

Illustrative embodiments disclosed herein advantageously avoid the above-described problems that can result when a source cluster makes IO connections with storage targets of a target cluster while unaware of IO processing loads of the respective storage targets of the target cluster.

Moreover, some embodiments are configured to allow the particular storage targets of the target cluster to be dynamically varied over time, as the load conditions on the storage targets change.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement hosts and distributed storage systems with adaptive IO connectivity functionality will now be described in greater detail with reference to FIGS. 4 and 5. Although described in the context of system 100, these platforms may also be used to implement at least portions of other information processing systems in other embodiments.

FIG. 4 shows an example processing platform comprising cloud infrastructure 400. The cloud infrastructure 400 comprises a combination of physical and virtual processing resources that may be utilized to implement at least a portion of the information processing system 100. The cloud infrastructure 400 comprises multiple virtual machines (VMs) and/or container sets 402-1, 402-2, . . . 402-L implemented using virtualization infrastructure 404. The virtualization infrastructure 404 runs on physical infrastructure 405, and illustratively comprises one or more hypervisors and/or operating system level virtualization infrastructure. The operating system level virtualization infrastructure illustratively comprises kernel control groups of a Linux operating system or other type of operating system.

The cloud infrastructure 400 further comprises sets of applications 410-1, 410-2,. . . 410-L running on respective ones of the VMs/container sets 402-1, 402-2,. . . 402-L under the control of the virtualization infrastructure 404. The VMs/container sets 402 may comprise respective VMs, respective sets of one or more containers, or respective sets of one or more containers running in VMs.

In some implementations of the FIG. 4 embodiment, the VMs/container sets 402 comprise respective VMs implemented using virtualization infrastructure 404 that comprises at least one hypervisor. Such implementations can provide adaptive IO connectivity functionality in a distributed storage system of the type described above using one or more processes running on a given one of the VMs. For example, each of the VMs can include logic instances and/or other components for implementing functionality associated with adaptive IO connectivity in the system 100.

A hypervisor platform may be used to implement a hypervisor within the virtualization infrastructure 404. Such a hypervisor platform may comprise an associated virtual infrastructure management system. The underlying physical machines may comprise one or more distributed processing platforms that include one or more storage systems.

In other implementations of the FIG. 4 embodiment, the VMs/container sets 402 comprise respective containers implemented using virtualization infrastructure 404 that provides operating system level virtualization functionality, such as support for Docker containers running on bare metal hosts, or Docker containers running on VMs. The containers are illustratively implemented using respective kernel control groups of the operating system. Such implementations can also provide adaptive IO connectivity functionality in a distributed storage system of the type described above. For example, a container host supporting multiple containers of one or more container sets can include logic instances and/or other components for implementing functionality associated with adaptive IO connectivity in the system 100.

As is apparent from the above, one or more of the processing devices or other components of system 100 may each run on a computer, server, storage device or other processing platform element. A given such element may be viewed as an example of what is more generally referred to herein as a “processing device.” The cloud infrastructure 400 shown in FIG. 4 may represent at least a portion of one processing platform. Another example of such a processing platform is processing platform 500 shown in FIG. 5.

The processing platform 500 in this embodiment comprises a portion of system 100 and includes a plurality of processing devices, denoted 502-1, 502-2, 502-3, . . . 502-K, which communicate with one another over a network 504.

The network 504 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 502-1 in the processing platform 500 comprises a processor 510 coupled to a memory 512.

The processor 510 may comprise a microprocessor, a microcontroller, an application-specific integrated circuit (ASIC), a field-programmable gate array (FPGA), graphics processing unit (GPU) or other type of processing circuitry, as well as portions or combinations of such circuitry elements.

The memory 512 may comprise random access memory (RAM), read-only memory (ROM), flash memory or other types of memory, in any combination. The memory 512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 502-1 is network interface circuitry 514, which is used to interface the processing device with the network 504 and other system components, and may comprise conventional transceivers.

The other processing devices 502 of the processing platform 500 are assumed to be configured in a manner similar to that shown for processing device 502-1 in the figure.

Again, the particular processing platform 500 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise various arrangements of converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the adaptive IO connectivity functionality provided by one or more components of a storage system as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, hosts, storage systems, storage nodes, storage devices, storage processors, initiators, targets, path selection logic instances, IO processing logic instances and other components. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

1. An apparatus comprising:
at least one processing device comprising a processor coupled to a memory;
the at least one processing device being configured:
to obtain, for a first storage system, information characterizing input-output (IO) processing loads of respective storage targets of a second storage system, the first storage system comprising a first set of storage nodes configured to interact with one or more host devices over a network, the second storage system comprising a second set of storage nodes, different than the first set of storage nodes, also configured to interact with the one or more host devices over the network, each of the storage nodes of the first and second sets of storage nodes comprising one or more storage targets; and
to configure a data service involving transfer of data from one or more of the storage targets of the first storage system to one or more of the storage targets of the second storage system based at least in part on the obtained information;
wherein configuring the data service comprises an initiator associated with the first storage system selecting a particular subset of the storage targets of the second storage system for use in implementing the data service based at least in part on the obtained information; and
wherein the information characterizing the IO processing loads of respective storage targets of the second storage system is obtained by the initiator associated with the first storage system at least in part from discovery information provided by the storage targets of the second storage system.

2. The apparatus of claim 1 wherein the first and second storage systems comprise respective first and second distinct clusters of storage nodes of at least one distributed storage system.

3. The apparatus of claim 1 wherein the data service comprises at least one of a replication service, a migration service and a copying service.

4. The apparatus of claim 1 wherein a given one of the storage targets of the second storage system comprises at least one Non-Volatile Memory Express (NVMe) controller of the second storage system.

5. The apparatus of claim 1 wherein each of one or more of the storage targets of the second storage system is configured to operate both as a data mobility interface to handle IO operations generated as part of one or more data services and as a host-storage interface to handle IO operations received in the storage target from one or more host devices.

6. The apparatus of claim 1 wherein the IO processing loads of the respective storage targets of the second storage system include processing of IO operations received in the storage targets from one or more host devices.

7. The apparatus of claim 1 wherein configuring the data service comprises establishing connectivity to the selected subset of the storage targets of the second storage system in conjunction with initiation of the data service.

8. The apparatus of claim 1 wherein at least the obtaining is performed in a first metadata manager associated with the first storage system.

9. The apparatus of claim 8 wherein the first metadata manager associated with the first storage system is configured to obtain the information from a second metadata manager associated with the second storage system.

10. The apparatus of claim 8 wherein the first metadata manager is implemented at least in part within the first storage system.

11. The apparatus of claim 8 wherein the first metadata manager is implemented at least in part within a management node separate from the first storage system.

12. The apparatus of claim 1 wherein selecting a particular subset of the storage targets of the second storage system for use in implementing the data service based at least in part on the obtained information comprises selecting a least-loaded subset of the storage targets of the second storage system for use in implementing the data service.

13. The apparatus of claim 1 wherein the selected subset of the storage targets of the second storage system that is used in implementing the data service is adaptively varied over time in response to one or more changes in the IO processing loads of the respective storage targets of the second storage system.

14. The apparatus of claim 1 wherein obtaining the information characterizing IO processing loads of respective storage targets of the second storage system comprises obtaining the information from discovery log pages that are reported by only those of the storage targets having IO processing loads below a designated threshold.

15. A computer program product comprising a non-transitory processor-readable storage medium having stored therein program code of one or more software programs, wherein the program code when executed by at least one processing device comprising a processor coupled to a memory, causes the at least one processing device:
to obtain, for a first storage system, information characterizing input-output (IO) processing loads of respective storage targets of a second storage system, the first storage system comprising a first set of storage nodes configured to interact with one or more host devices over a network, the second storage system comprising a second set of storage nodes, different than the first set of storage nodes, also configured to interact with the one or more host devices over the network, each of the storage nodes of the first and second sets of storage nodes comprising one or more storage targets; and
to configure a data service involving transfer of data from one or more of the storage targets of the first storage system to one or more of the storage targets of the second storage system based at least in part on the obtained information;
wherein configuring the data service comprises an initiator associated with the first storage system selecting a particular subset of the storage targets of the second storage system for use in implementing the data service based at least in part on the obtained information; and
wherein the information characterizing the IO processing loads of respective storage targets of the second storage system is obtained by the initiator associated with the first storage system at least in part from discovery information provided by the storage targets of the second storage system.

16. The computer program product of claim 15 wherein the selected subset of the storage targets of the second storage system that is used in implementing the data service is adaptively varied over time in response to one or more changes in the IO processing loads of the respective storage targets of the second storage system.

17. The computer program product of claim 15 wherein obtaining the information characterizing IO processing loads of respective storage targets of the second storage system comprises obtaining the information from discovery log pages that are reported by only those of the storage targets having IO processing loads below a designated threshold.

18. A method comprising:
obtaining, for a first storage system, information characterizing input-output (IO) processing loads of respective storage targets of a second storage system, the first storage system comprising a first set of storage nodes configured to interact with one or more host devices over a network, the second storage system comprising a second set of storage nodes, different than the first set of storage nodes, also configured to interact with the one or more host devices over the network, each of the storage nodes of the first and second sets of storage nodes comprising one or more storage targets; and
configuring a data service involving transfer of data from one or more of the storage targets of the first storage system to one or more of the storage targets of the second storage system based at least in part on the obtained information;
wherein configuring the data service comprises an initiator associated with the first storage system selecting a particular subset of the storage targets of the second storage system for use in implementing the data service based at least in part on the obtained information;
wherein the information characterizing the IO processing loads of respective storage targets of the second storage system is obtained by the initiator associated with the first storage system at least in part from discovery information provided by the storage targets of the second storage system; and
wherein the method is performed by at least one processing device comprising a processor coupled to a memory.

19. The method of claim 18 wherein the selected subset of the storage targets of the second storage system that is used in implementing the data service is adaptively varied over time in response to one or more changes in the IO processing loads of the respective storage targets of the second storage system.

20. The method of claim 18 wherein obtaining the information characterizing IO processing loads of respective storage targets of the second storage system comprises obtaining the information from discovery log pages that are reported by only those of the storage targets having IO processing loads below a designated threshold.
